(19) United States
(12) Patent Application Publication
(10) Pub. No.: US 2026/0116810 A1
(43) Pub. Date: Apr. 30, 2026

(54) LEAD-FREE CRYSTAL COMPOSITION, GLASS AND GLASS ARTICLE MADE FROM THIS COMPOSITION

(71) Applicant: BACCARAT, Baccarat (FR)

(72) Inventors: Daniel COILLOT, Neuves-Maisons (FR); Eric BRIENT, Raon I'Etape (FR)

(73) Assignee: BACCARAT, Baccarat (FR)

(21) Appl. No.: 19/117,203

(22) PCT Filed: Sep. 26, 2023
(86) PCT No.: PCT/EP2023/076490

§ 371 Date: Mar. 31, 2025

(30) Foreign Application Priority Data
Sep. 29, 2022 (EP) 22306445.2

(51) Int. Cl. C03C 3/095; C03C 3/078

(52) U.S. Cl. CPC C03C 3/095; C03C 3/078

(57) ABSTRACT

A lead-free crystal glass composition includes 58 to 64% by weight of SiO₂, 0 to 0.5% by weight of Al₂O₃, a mixture of alkali oxides and alkaline earth oxides including 13.8 to 18% by weight of a mixture of alkali oxides including K₂O and Na₂O, and 9 to 15% by weight of a mixture of alkaline earth oxides including BaO and SrO, the ratio of the mole percentage of the mixture of alkali oxides to the mole percentage of the mixture of alkaline earth oxides being between approximately 2 and approximately 3, 6 to 10% by weight of ZnO, 0 to 1.20% by weight of Sb₂O₃, 0 to 0.5% by weight of SO₃, 0 to 6.8% by weight of TiO₂ and 0 to 6% by weight of La₂O₃, and 0 to 10% of colouring agents.

### SUBJECT MATTER OF THE INVENTION

The present invention relates to a crystal glass composition containing substantially no Lead, however, the glass obtained based on this composition, and the articles made from such glass, possess properties and characteristic features that are identical or similar to those of lead crystal glass.

### STATE OF THE ART

Lead crystal glass articles, whether they be articles of/for tableware, decor, lighting fixtures, or jewellery, are commonly manufactured from compositions comprising a vitreous base and at least a significant proportion of lead oxide, which is generally greater than 24% or 30% by weight of the total weight of the composition.

Usually, they are obtained by a step of melting of the constituents of the compositions, usually also with lead crystal glass to be recycled, in continuous casting melting furnaces, or tank furnaces, or batch casting furnaces, or pot furnaces, followed by the implementation of steps of hot working, hot shaping, in order to form the articles, which are subsequently subjected to steps of cold working, or machining, which generally consist of one or more steps of sawing, slitting, cutting, drilling, mechanical polishing, or any combination of the said steps. Usually, the articles are also subjected to an acid polishing step, carried out using a mixture of fluoridric acid (HF) and sulphuric acid (H₂SO₄), followed by a rinsing of the residual salts. Steps of completion, or finishing, may be carried out in order, for example, to apply a decoration to the surface of the articles.

The proportions of lead used in the lead crystal glass compositions, allow to reduce the melting temperature and the working temperature thereof, as compared to a composition that does not comprise any lead. They allow to increase the malleability thereof and to obtain a viscosity that renders possible the working and shaping of the crystal within a range of temperatures from 600° C. to 1200° C. They also allow the lead crystal glass to acquire a softness that renders it easy to polish, engrave or cold-cut, as well as particular levels of luster, density and sonority, and excellent chemical durability characterised by good hydrolytic resistance, all of which are characteristic of lead crystal.

Nevertheless, given that lead is toxic and that there is a risk of it migrating to products which come into contact with a crystal glass, so-called ‘alternative’ crystal compositions having a reduced percentage of lead oxide, or indeed even so-called ‘lead-free crystal’ compositions, have been proposed.

These alternative lead-free crystal compositions generally comprise a vitreous base, which may be Silica (SiO₂) based for a silicate glass, or Silica and aluminium oxide (Al₂O₃) based for an aluminosilicate glass, or Silica, aluminium oxide and boron oxide (B₂O₃) based for an aluminoborosilicate glass, and a set of modifier components for modifying the vitreous base, particular additives, such as, for example, one or more fluxes, stabilisers, refining agents, and optionally a set of colouring or decolourising components, allowing to approximate or reproduce the properties and characteristics of a crystal composition and of a lead crystal glass, in particular with regard to shaping, and thus to hot viscosity, density, refractive index and sonority.

For example, the document U.S. Pat. No. 6,235,667 describes a composition of a silicate or aluminosilicate glass, having a density greater than 2.9 g/cm³ and a refractive index greater than 1.545, which does not comprise lead, and which is suitable for the production of manufactured articles of tableware and/or decorative crystalware. The composition comprises, in percentage by weight, 50 and 58% of SiO₂ and 0 to 3% of Al₂O₃, in which the lead has been replaced by a mixture of zinc, barium, lanthanum, niobium and bismuth, representing between 26% to 33% by weight, with the zinc oxide being between 16 and 30% by weight, the content of barium and bismuth oxides each being from 0 to 13% by weight, and the sum of these oxides excluding zinc being between 7 and 14%. The composition further comprises 12 to 18% by weight of oxides of potassium, sodium and lithium, one or more of the components selected from among Sb₂O₃, AS₂O₃, NiO, CoO, MnO₂, Er₂O₃, Nd₂O₃, SeO and CeO₂, as refining and decolourising agents, in a total amount of less than 2% by weight, with Sb₂O₃ representing 0 to 1% by weight, and may include zirconium oxide, yttrium oxide and titanium oxide in a combined total content of less than 6% by weight.

The document EP1725502 describes a composition of a lead-free and barium-free crystal, which is an alumino-boro-silicate glass, having a refractive index of at least 1.55. The composition comprises, by weight, 50 to 60% of SiO₂, 0.6 to 4% of B₂O₃, 0.25 to 5% of Al₂O₃, 0 to 3% of K₂O, 12 to 15% of Na₂O, 4 to 11% of CaO, 0 to 2% of MgO, 0 to 5% of TiO₂, 8 to 16% of ZnO, with the total content of oxides of Pb, Ba, As being less than 0.1%; the total content of oxides of Ti and La being less than 5%, the total content of oxides of Nb, Ta, Yb, Y, W, Bi, Zr being less than 5%, with less than 1% of each oxide of Nb, Ta, Yb, and less than 3% of each oxide of Y, W, Bi, Zr.

The document CN105837045 describes a composition of a glass, which may be a silicate, borosilicate or aluminosilicate, lead-free and barium-free, having a refractive index greater than or equal to 1.545, and a density greater than or equal to 2.9 g/cm³, to manufacture tableware articles. The composition comprises, by weight, 50 to 65% of SiO₂, 0 to 5% of Al₂O₃, 0 to 5% of B₂O₃, 0 to 3% of Li₂O, 0 to 15% of Na₂O, 0 to 10% of K₂O, 0 to 10% of La₂O₃, 0 to 15% of SrO, with ZnO being greater than or equal to 8% but less than 16%.

Although such lead-free crystal glass compositions allow to obtain a glass having a density and refractive index that are equivalent to those of lead crystal glass, they present a number of drawbacks during the melting process and in the subsequent steps involved in the manufacture of the articles. The compositions may exhibit a crystallisation phenomenon during hot working. In addition, during hot forming of the articles, the molten material proves to be poorly suited, if at all, to the manufacture of large parts, for example weighing between 1 kg and 50 kg, or parts with complex forms or shapes. Furthermore, compositions containing boron oxide and/or bismuth oxide, and high content levels of alkali oxides, in particular lithium oxide, interact strongly, at high temperature, with the refractory elements that form integral parts of the furnaces in which the melting step is carried out. This results in premature wear of these refractory elements, leading to a reduction in the useful life of the furnaces and potentially to undesirable discolouration of the glass.

### Objectives of the Invention

The present invention aims to provide a crystal glass composition that contains substantially no lead, a crystal glass that is substantially lead-free and an article made from such a glass, which do not have the drawbacks of the state of the art.

The present invention aims to provide an alternative to existing state of the art solutions.

The present invention aims to provide a composition having an ease implementation and allowing an improved shaping at operating temperatures similar to those for a lead crystal glass composition, and which imparts to the glass obtained from the composition, and to the article made from the said glass, characteristics and properties that are similar or identical to those of a lead crystal glass or a lead crystal glass article.

The object of the present invention also relates to the use of the composition according to the invention for the production of a lead-free crystal glass and a lead-free crystal glass article containing substantially no lead.

### SUMMARY OF THE INVENTION

The present invention relates to a lead-free crystal glass composition comprising 58 to 64% by weight of SiO₂, 0 to 0.5% by weight of Al₂O₃, a mixture of alkali oxides and alkaline earth oxides consisting of: 13.8 to 18% by weight of a mixture of alkali oxides consisting of K₂O and Na₂O, and 9 to 15% by weight of a mixture of alkaline earth oxides consisting of BaO and SrO, the ratio of the mole percentage of the mixture of alkali oxides to the mole percentage of the mixture of alkaline earth oxides being between approximately 2 and approximately 3, 6 to 10% by weight of ZnO, 0 to 1.20% by weight of Sb₂O₃, 0 to 0.5% by weight of SO₃, 0 to 6.8% by weight of TiO₂ and 0 to 6% by weight of La₂O₃, and 0 to 10% of colouring or decolourising agents.

According to particular embodiments of the invention, the composition according to the invention comprises at least one, or any suitable combination, of the following features:
the mixture of alkali oxides consists of 8 to 10% by weight of K₂O and 5.8 to 8% by weight of Na₂O,
the mixture of alkaline earth oxides consists of 8.5 to 12% by weight of BaO, and 0.5 to 3% by weight of SrO,
the ratio of the mole percentage of the mixture of alkali oxides to the mole percentage of the mixture of alkaline earth metal oxides is equal to approximately 2,
the mole percentage of the mixture of alkali oxides to the mole percentage of the mixture of alkaline earth oxides is equal to approximately 2.5.

The present invention also relates to the use of the composition according to the invention for the production of a lead-free crystal glass.

The present invention also relates to a lead-free crystal glass material based on the composition, which preferably has a refractive index of between 1.537 and 1.559, and a density of between 2.77 and 3.03.

The present invention further relates to the use of the lead-free crystal glass according to the invention in order to produce an article made from lead-free crystal glass.

The present invention also relates to a lead-free crystal article that is made from, or comprises, the glass according to the invention, which, in some particular embodiments, is an article of tableware, a decorative article, a piece of jewellery, an element of a lighting fixture or a lighting fixture.

### DETAILED DESCRIPTION OF THE INVENTION

In the following description and the claims, the terms ‘percentage by weight’ mean that the percentage indicated for a component is related to the total mass of the composition, and similarly, the terms ‘percentage by mole’, or ‘mole percentage’, mean that the percentage indicated is related to the total number of moles in the composition. The terms ‘trace(s)’ or ‘impurity(ies)’ mean that the compound in question is found to be present in an amount less than or equal to 0.05% by weight.

The composition according to the invention is referred to as a ‘lead-free crystal’ glass composition, because the glass based on, obtained from, the said composition possesses properties and characteristics that are identical or similar to those of a lead crystal glass, while however, comprising substantially no lead.

The composition according to the invention comprises substantially no lead oxide, while however exhibiting properties and characteristics that are identical, similar or very close to those of a lead crystal glass composition, in particular in terms of offering the possibility for the composition, to be melted and refined under the operating conditions, in particular with respect to temperature, normally used for a lead crystal, and with the same means, but also in terms of its suitability to be worked by hand in order to obtain pressed and blown articles, as well as its suitability to be cold-shaped, similar to that of lead crystal.

The composition according to the invention comprises a vitreous base that comprises silica, but substantially no boron or boron oxide, phosphorus or phosphorus oxide, or bismuth or bismuth oxide, other than in trace amounts or as impurities. It may optionally comprise aluminium oxide, which presents the advantage of increasing the stability and durability of the glass.

The composition according to the invention is not a vitroceramic glass composition. It does not comprise a crystalline phase present in the form of crystals dispersed within the vitreous phase.

The composition according to the invention comprises by weight 58 to 64% of SiO₂, and where present, less than 0.5% of Al₂O₃.

The composition further comprises a mixture of alkali and alkaline earth oxides.

The mixture of alkali oxides consists of 13.8 and 18% by weight of a mixture of potassium oxide (K₂O) and sodium oxide (Na₂O). It does not comprise other alkali metal oxides, in particular it does not comprise lithium and/or caesium oxides, other than in trace amounts or as impurities. Preferably, K₂O is present in an amount of between 8 and 10% by weight, that is to say 6 to 9 mol %, and Na₂O is present in an amount of between 5.8 and 8% by weight, that is to say 6 to 9.2 mol %. Preferably, the ratio of the mole percentage of K₂O to the mole percentage of Na₂O is about 1.

The potassium- and sodium oxides are modifiers of the vitreous network and are fluxes. In combination and in the proportions according to the invention, these oxides present the advantages of maximising their effects on the thermal properties of the glass, lowering the melting temperature of the vitreous base, reducing the viscosity of the glass at high temperature, and facilitating clarification and homogenisation, while limiting corrosion of the refractory elements constituting integral parts of the furnace, during the melting step.

The mixture of alkaline earth oxides consists of 9 and 15% by weight of a mixture of barium oxide (BaO) and strontium oxide (SrO). It does not comprise other alkaline earth metal oxides, in particular it does not comprise calcium and/or magnesium oxides, other than in trace amounts or as impurities. Preferably, BaO is present in an amount of between 8.5 and 12% by weight, that is to say 4 to 6 mol %, and SrO is present in an amount of between 0.5 and 3% by weight, that is to say 0.3 to 3 mol %. Preferably, the ratio of the mole percentage of BaO to the mole percentage of SrO is between approximately 2.7 and 11.5%.

Barium oxide and strontium oxide are heavier stabilisers than the calcium and magnesium oxides conventionally used. They have the advantage of increasing the hot viscosity while also increasing the density of the glass obtained and its refractive index. In addition, they also enhance the hot workability of the composition, ensuring a higher working level. In the proportions according to the invention, they present the advantage of amplifying their effects, without exhibiting any of the drawbacks of barium oxide and strontium oxide alone, at such content levels.

The ratio of the sum of the mole percentages of the alkali oxides to the sum of the mole percentages of the alkaline earth oxides, namely the ratio (mol % K₂O+mol % Na₂O)/(mol % BaO+mol % SrO), is comprised between approximately 2 and approximately 3. Preferably, this ratio is equal to approximately 2, 2.25, 2.5, 2.75, 2.79 or 3. Advantageously, this ratio is equal to 2.5.

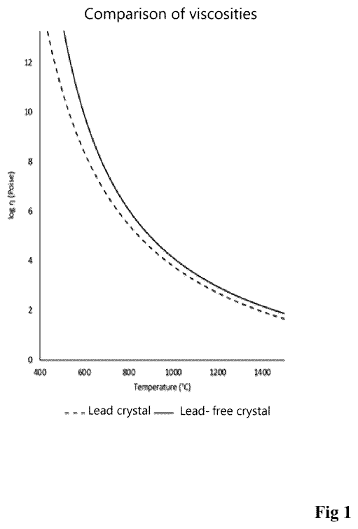

Such a mixture of alkali and alkaline earth oxides modifies the viscosity profile, in particular between the glass forming temperature, which corresponds to a viscosity of 103 Poise, and the softening temperature, which corresponds to a viscosity of 107.65 Poise, of the glass material based on the composition according to the invention as compared with that of a glass composition such as crystalline or soda-lime glass composition. This has the advantageous to obtain a glass which sets less quickly and therefore to enhance its hot workability (FIG. 1).

The composition further comprises zinc oxide, but does not comprise other oxides of the lead family, other than possibly tin oxide. In any event, it does not comprise oxides of bismuth, gallium and/or cadmium, other than in trace amounts or as impurities. The zinc oxide represents between 6 and 10% by weight of the composition according to the invention. Where tin oxide is present, it may be present in an amount of up to 2% by weight.

In the composition according to the invention, zinc oxide plays a role similar to that of lead in a lead crystal glass. It allows to stabilise the glass when hot, allows to increase its chemical durability when cold, and allows to increase the refractive index of the glass obtained.

This combination of barium-, strontium- and zinc oxides offers the advantage of enhancing the stability of the glass when hot, by limiting crystallisation.

The composition may further comprise antimony oxide, preferably representing between 0 and 1.20% by weight. This has the advantage to obtain a homogeneous glass that is free from residual bubbles. Moreover, during the melting process, it provides excess oxygen, which makes it possible to obtain an oxidised glass that is easier to control through the melting process, thereby in particular providing for a certain degree of colour stability.

Preferably, the composition may further comprise one or more sulphates, in addition to the antimony oxide, which has the advantage of oxidising the glass and extending the refining temperature range during the melting step over and above the simple action of the antimony oxide. The one or more sulphate(s) are present in the form of precursors such as, for example, Na₂SO4, K₂SO4, SrSO4, BaSO4, and a combination thereof.

The composition may further also comprise an oxide of a transition metal, preferably titanium oxide, preferably representing less than 1% by weight. This presents the advantage of lowering the melting temperature of the glass and increasing the refractive index. The titanium oxide may also contribute to the colouring of the glass. In this case, the content thereof may represent up to 6.8% by weight.

The composition may further also comprise an oxide of a lanthanide, preferably lanthanum oxide, representing 0 to 6%. This presents the advantage of making the composition heavier and increasing the density of the glass, while retaining a high refractive index and good workability.

The composition may further also comprise colouring or decolourising agents, preferably in order to mask the tint imparted by the impurities or indeed to obtain tinted glasses. Preferably, the composition may comprise metal oxides such as V₂O₅, Cr₂O₃, MnO, Fe₂O₃, CoO, NiO, CuO, SnO₂; lanthanide oxides such as CeO₂, Pr₂O₃, Nd₂O₃, Er₂O₃, or precious metals such as Ag and Au.

Preferably, the composition does not comprise any components other than those mentioned above. The composition thus then is constituted of: 58 to 64% by weight of SiO₂, 0 to 0.5% by weight of Al₂O₃, 5.8 to 8% by weight of Na₂O, 8 to 10% by weight of K₂O, 8.5 to 12% by weight of BaO, 0.5 to 3% by weight SrO, with the ratio of the sum of the mole percentages of Na₂O and K₂O to the sum of the mole percentages of BaO and SrO being between 2 and 3, from 6 to 10% by weight of ZnO, 0 to 1.2% by weight of Sb₂O₃, 0 to 0.5% by weight of SO₃, 0 to 6.8% by weight of TiO₂, 0 to 6% by weight of La₂O₃ and 0 to 10% by weight of colouring agents, with the sum of these components representing 100% of the total weight of the composition.

Examples of compositions according to the invention are provided below in Tables 1 and 2.

TABLE 1

| | Oxides | A | B | C | D | E |
|---|---|---|---|---|---|---|
| | SiO₂ | 58.0 | 58.0 | 64.0 | 58.0 | 58.5 |
| Composition | Al₂O₃ | — | — | 0.5 | — | — |
| (% pds) | Na₂O | 5.8 | 8.0 | 6.2 | 6.2 | 6.3 |
| | K₂O | 8.0 | 10.0 | 9.2 | 9.0 | 9.1 |
| | BaO | 8.5 | 12.0 | 10.3 | 10.0 | 10.4 |
| | SrO | 0.5 | 3.0 | 0.8 | 0.8 | 1.2 |
| | ZnO | 6.0 | 6.0 | 8.0 | 10. | 9.2 |
| | Sb₂O₃ | 0.8 | 1.2 | — | — | 1.0 |
| | SO₃ | — | — | — | — | — |
| | TiO₂ | 6.8 | 1.0 | — | — | 0.3 |
| | La₂O₃ | 3.0 | 0.8 | 1.0 | 6.0 | 4 |
| | CeO₂ | 2.6 | — | — | — | — |
| | CoO | — | — | — | — | — |
| | Cr₂O₃ | — | — | — | — | — |
| | CuO | — | — | — | — | — |
| | Fe₂O₃ | — | — | — | — | — |
| | SnO₂ | — | — | — | — | — |
| | | 100.0 | 100.0 | 100.0 | 100.0 | 100.0 |

TABLE 2

| | Oxides | F | G | H | I | J |
|---|---|---|---|---|---|---|
| | SiO₂ | 62.6 | 61.0 | 58.0 | 58.1 | 58.7 |
| Composition | Al₂O₃ | — | — | — | — | 0.1 |
| (% pds) | Na₂O | 6.4 | 5.9 | 5.8 | 6.2 | 6.7 |
| | K₂O | 8.8 | 9.0 | 8.9 | 9.2 | 9.3 |
| | BaO | 10.7 | 10.5 | 10.3 | 10.3 | 10.5 |
| | SrO | 2.6 | 2.5 | 2.5 | 0.8 | 1.0 |
| | ZnO | 7.4 | 7.3 | 7.2 | 8.5 | 8.9 |
| | Sb₂O₃ | 0.9 | 0.9 | 0.8 | 1.2 | 0.8 |
| | SO₃ | — | — | — | — | 0.5 |
| | TiO₂ | 0.6 | — | 0.6 | 0.2 | 0.3 |
| | La₂O₃ | — | 2.3 | 4.5 | 3.5 | 3.2 |
| | CeO₂ | — | — | — | — | — |
| | CoO | — | — | 0.1 | — | — |
| | Cr₂O₃ | — | 0.6 | 0.5 | — | — |
| | CuO | — | — | 0.4 | — | — |
| | Fe₂O₃ | — | — | 0.4 | — | — |
| | SnO₂ | — | — | — | 2.0 | — |
| | | 100.0 | 100.0 | 100.0 | 100.0 | 100.0 |

The composition according to the invention should be understood to be the mixture of the components, or raw materials, of which it is composed, and which are melted in a furnace. The molten mass, and hence the glass based on, or obtained from, the composition according to the invention, no longer comprise the raw materials of the composition as such, but rather the products of the reaction thereof. Furthermore, the molten mass and the glass may in addition comprise contaminants, minerals or mineral oxides, originating from contamination occurring during the process of obtaining the molten mass and the glass, for example during the time spent in the furnace. For example, the melt and the glass obtained may comprise zirconium or zirconium oxide, originating from the refractory elements of the furnace, which may represent up to 1% by weight of the total mass of the raw materials of the composition.

The composition according to the invention presents the advantage of being able to be used using the techniques, tools and, in particular, the furnaces employed for the production of lead crystal glass and lead crystal glass articles.

The composition according to the invention is used to produce the lead-free crystal glass according to the invention.

The lead-free crystal glass according to the invention is obtained from the composition according to the invention. It may be a silicate or aluminosilicate glass, it is not however an alumino-boro-silicate glass. It exhibits physical and mechanical properties that are identical, equivalent or very similar to those of lead crystal glass, as well as an equivalent sonority.

The lead-free crystal glass according to the invention has a refractive index, measured by means of an Abbe refractometer, comprised between 1.537 and 1.559, an Abbe number that is greater than 42, preferably between 54 and 56.

It has a density of between 2.77 and 3.03, preferably between 2.70 and 2.90.

The lead-free crystal glass according to the invention has a refractive index of between 1.537 and 1.559, and a density of between 2.77 and 3.03.

The lead-free crystal glass according to the invention presents a Vickers hardness Hv0.1 greater than or equal to 436 kg/mm², preferably between 526 and 549 kg/mm².

It has an elasticity characterised by a Young's modulus greater than 59 GPa, preferably between 66 and 69.5 GPa.

It has a hydrolytic resistance, measured according to the standard ISO719, of between 122 and 132 μg/g expressed as R₂O.

The lead-free crystal glass according to the invention is used to produce a lead-free crystal article. The glass is shaped in order to impart to it a particular form, surface texture, etchings or other particular marking features which are determined on the basis of the end use and/or the final destination of the article. The lead-free crystal glass may also, potentially, be coated with one or more decorative elements. As a result of these modifications, the glass is transformed into a lead-free crystal glass article.

The lead-free crystal glass article according to the invention is made from, or comprises, the lead-free crystal glass according to the invention, and one or more coatings of metals and/or precious metals and/or polymers, which are deposited on a substrate that is made from the glass, or comprises the glass, according to the invention, one or more etchings or markings, one or more surface textures, or a combination thereof.

The lead-free crystal glass article according to the invention is preferably an artificial jewellery item; a tableware article, such as crockery; a decorative article; a lighting fixture element; or an element of ornamental and decor articles.

1. Lead-free crystal glass composition comprising:
58 to 64% by weight of SiO₂;
0 to 0.5% by weight of Al₂O₃;
a mixture of alkali oxides and alkaline earth oxides consisting of: 13.8 to 18% by weight of a mixture of alkali oxides consisting of K₂O and Na₂O, and 9 to 15% by weight of a mixture of alkaline earth oxides consisting of BaO and SrO, the ratio of the mole percentage of the mixture of alkali oxides to the mole percentage of the mixture of alkaline earth oxides is comprised between approximately 2 and approximately 3;
6 to 10% by weight of ZnO,
0 to 1.20% by weight of Sb₂O₃,
0 to 0.5% by weight of SO₃,
0 to 6.8% by weight of TiO₂,
0 to 6% by weight of La₂O₃ and
0 to 10% of colouring or decolourising agents.

2. The composition according to claim 1, wherein the mixture of alkali oxides consists of 8 to 10% by weight of K₂O and 5.8 to 8% by weight of Na₂O.

3. The composition according to claim 1, wherein the mixture of alkaline earth oxides consists of 8.5 to 12% by weight of BaO, and 0.5 to 3% by weight of SrO.

4. The composition according to claim 1, wherein the ratio of the mole percentage of the mixture of alkali oxides to the mole percentage of the mixture of alkaline earth metal oxides is equal to approximately 2.

5. The composition according to claim 1, wherein the ratio of the mole percentage of the mixture of alkali oxides to the mole percentage of the mixture of alkaline earth oxides is equal to approximately 2.5.

6. A lead-free crystal glass produced from the lead-free crystal glass composition of claim 1.

7. Lead-free crystal glass material based on the composition according to claim 1.

8. A lead-free crystal glass according to claim 7, that has a refractive index of between 1.537 and 1.559, and a density of between 2.77 and 3.03.

9. An article made from the lead-free crystal glass of claim 7.

10. Lead-free crystal article that is made from, or comprises, the glass according to claim 7.

11. The lead-free crystal article according to claim 10, being an article of tableware, a decorative article, a piece of jewellery, an element of a lighting fixture or a lighting fixture.
